(19) United States
(12) Patent Application Publication
(10) Pub. No.: US 2013/0291395 A1
(43) Pub. Date: Nov. 7, 2013

(54) LAUNDRY TREATING MACHINE AND CONTROL METHOD THEREOF

(71) Applicants: Youngjin Doh, Changwon-si (KR); Taewan Kim, Changwon-si (KR); Kyuhwan Lee, Changwon-si (KR)

(72) Inventors: Youngjin Doh, Changwon-si (KR); Taewan Kim, Changwon-si (KR); Kyuhwan Lee, Changwon-si (KR)

(21) Appl. No.: 13/874,498

(22) Filed: May 1, 2013

(30) Foreign Application Priority Data
May 3, 2012 (KR) 10-2012-0046941

(51) Int. Cl. F26B 21/08

(52) U.S. Cl. CPC F26B 21/086
USPC 34/468; 34/282; 34/73

(57) ABSTRACT

A laundry treating machine and a control method thereof are provided. The laundry treating machine may include a drum rotatably provided in a tub, an air supply device to supply air to the tub, a cooling water supply device to supply cooling water to an inner surface of the tub such that moisture contained in air is condensed at the inner surface of the tub, and a controller to control the cooling water supply device to selectively supply cooling water based on user selection. When a drying course is selected, the controller determines a particular drying course to be performed and, based on the determined drying course, either cooling water necessary to generate condensed water is supplied, or the supply of cooling water is stopped, and the drying course is performed.

### CROSS-REFERENCE TO RELATED APPLICATION(S)

This application claims priority under 35 U.S.C. §119 to Korean Application No. 10-2012-0046941 filed on May 3, 2012, whose entire disclosure is hereby incorporated by reference.

### BACKGROUND

1. Field

This relates to a laundry treating machine and a control method thereof.

2. Background

Laundry treating machines may include washing machines and washing machines having a drying function. A washing machine may remove various kinds of contaminants from laundry items using emulsification, friction caused by rotation of a pulsator or a drum, and impact applied to the laundry. Some washing machines may automatically perform a series of courses including a washing course, a rinsing course, and a spin-drying course without user manipulation.

A washing machine with a drying function may perform the functions of a washing machine and dry the laundry after washing. For example, a condensation type washing machine with a drying function may withdraw air from a tub, remove moisture from the air using condensed water, heat the air, and introduce the heated air into the tub.

### BRIEF DESCRIPTION OF THE DRAWINGS

The embodiments will be described in detail with reference to the following drawings in which like reference numerals refer to like elements wherein:

FIG. 1 is a side sectional view of an exemplary condensation type washing machine with a drying function;

FIG. 2 is an exploded perspective view of a laundry treating machine according to an embodiment as broadly described herein;

FIG. 3 is a side sectional view of the laundry treating machine shown in FIG. 2;

FIG. 4 is a perspective view of a suspension device of the laundry treating machine shown in FIGS. 2-3;

FIG. 5 is a side view of a coupling state between a tub and the suspension device of the laundry treating machine shown in FIGS. 2-3;

FIG. 6 is a perspective view of an air supply device and the tub of the laundry treating machine shown in FIGS. 2-3;

FIG. 7 is a partial sectional view of a hot air collection port and a filter cleaning device of the laundry treating machine shown in FIGS. 2-3;

FIG. 8 is a schematic view of a rear inner surface of the tub of the laundry treating machine according shown in FIGS. 2-3;

FIG. 9 is a partial sectional view taken along line A-A′ of FIG. 8;

FIG. 10 is a schematic view of a control panel of the laundry treating machine shown in FIGS. 2-3; and

FIG. 11 is a flowchart of a drying course performed by the laundry treating machine shown in FIGS. 2-10.

### DETAILED DESCRIPTION

Reference will now be made in detail to various embodiments, examples of which are illustrated in the accompanying drawings. Wherever possible, the same reference numbers will be used throughout the drawings to refer to the same or like parts.

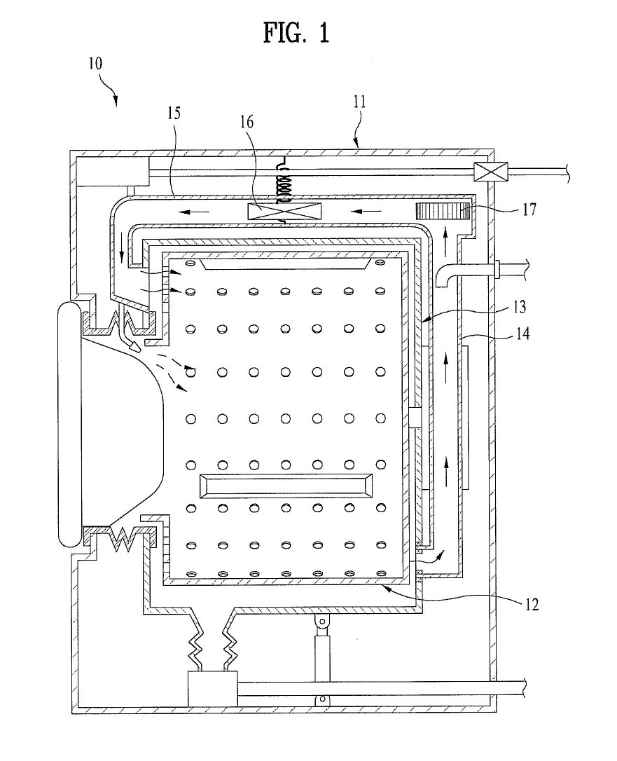

FIG. 1 is a perspective view of an exemplary condensation type washing machine 10 with a drying function. As shown in FIG. 1, the washing machine 10 may include a cabinet 11 having a receiving space defined therein, a tub 12 received in the cabinet 11, a drum 13 rotatably mounted in the tub 12, a condensing duct 14 formed outside the tub 12 to condense air containing moisture generated from the tub 12, a heating duct 15 connected to a downstream end of the condensing duct 14 to heat air using a heater 16 and to supply the heated air into the tub 12, and a blowing fan 17 to circulate air from the tub 12 through the condensing duct 14 and the heating duct 15. In this washing machine 10, air moved by the blowing fan 17 during drying may be heated by the heater 16 provided in the heating duct 15, and the heated air may be supplied into the tub 12 to dry the laundry during rotation of the drum 13.

The air used to dry the laundry becomes humid and is introduced into the condensing duct 14 from the tub 12. In the condensing duct 14, moisture is removed from the humid air. Additional cooling water to condense the humid air may be supplied into the condensing duct 14 to facilitate condensation. The heated air may then be resupplied to the tub 12 via the heating duct 15 by the blowing fan 17. Air is circulated through the above processes.

The condensing duct 14 may have a pipe shape to facilitate air blowing capacity of the blowing fan 17 and smooth flow of air. Moisture contained in humid air may be condensed through heat exchange between the inner surface of the condensing duct 14 and the humid air. As a result, the moisture may be removed from the air. It may be necessary to continuously supply a relatively large amount of cooling water during a drying cycle in order to sufficiently condense moisture from humid air introduced into the condensing duct 14. In certain circumstances, cooling water may be continuously supplied during drying of laundry, regardless of user selection. That is, even when a user does not wish to use cooling water, cooling water is supplied, increasing cooling water consumption.

In certain embodiments, the area of the condensing duct 14 for heat exchange with humid air may be relatively small and thus it may be necessary to supply a relatively large amount of cooling water for a relatively long period of time, also increasing cooling water consumption.

In addition, during drying of laundry, lint contained in the laundry may be introduced into the condensing duct 14 together with air and then remain in the condensing duct 14, the blowing fan 17, and the heating duct 15. The lint remaining in the condensing duct 14 may reduce efficiency of the condensing duct 14. The lint remaining in the blowing fan 17 may cause the blowing fan 17 to malfunction. The lint remaining in the heating duct 15 may cause malfunction or combustion of the heater 16 provided in the heating duct 15.

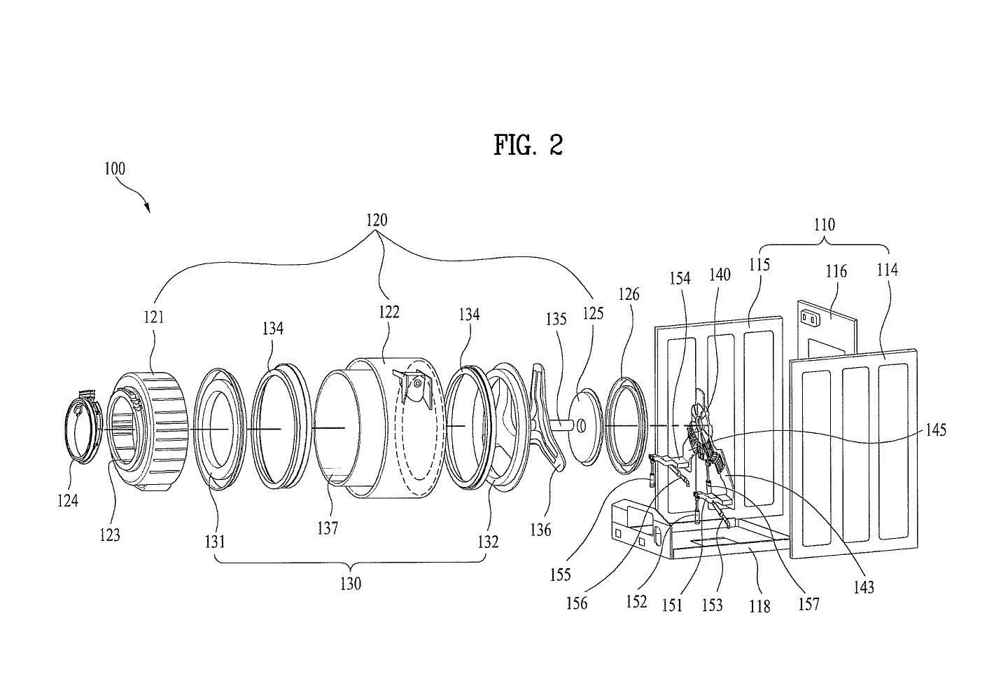

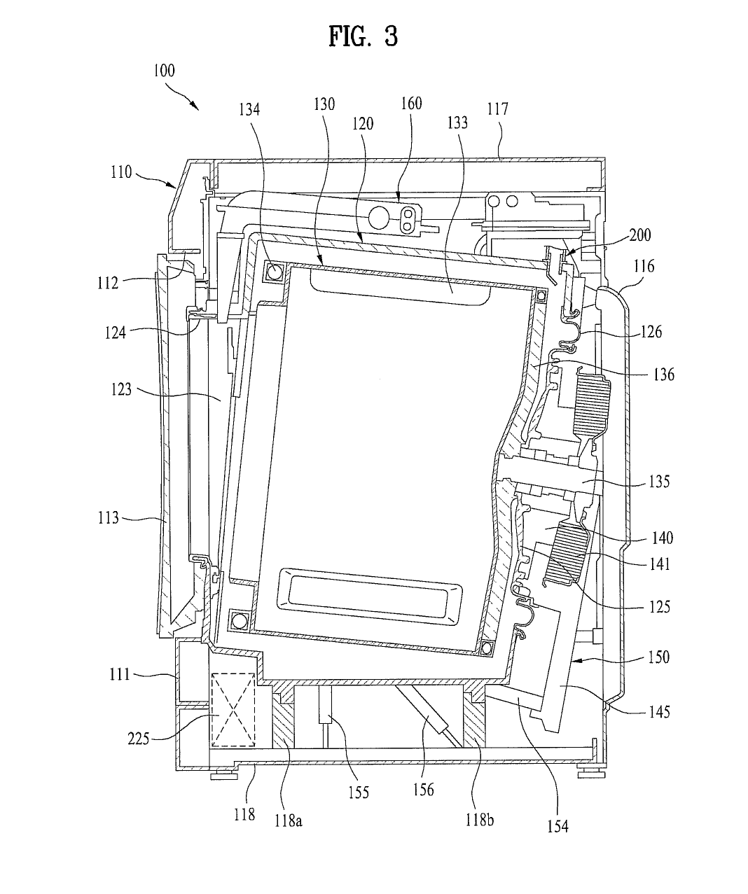

FIG. 2 is an exploded perspective view showing a laundry treating machine 100 according to an embodiment as broadly described herein, and FIG. 3 is a side sectional view of the internal structure of the laundry treating machine shown in FIG. 2.

As shown in FIGS. 2 and 3, the laundry treating machine 100 may include a cabinet 110 forming the external appearance of the laundry treating machine 100, a tub 120 fixedly mounted in the cabinet 110 and having an inner surface used as a cooling surface to generate condensed water, a drum 130 rotatably mounted in the tub 120, a rotary shaft 135 connected to the drum 130 through the rear of the tub 120, a bearing housing 140 to support the rotary shaft 135, a drive motor 141 provided at the bearing housing 140 to transmit rotary force to the rotary shaft 135, a suspension device 150 coupled to the bearing housing 140 to support components connected to the bearing housing 140 and, at the same time, to absorb vibration and/or impact, an air supply device 160 fixedly mounted to the outside of the tub 120 to heat air and to supply the heated air into the tub 120, and a controller 225 connected to the respective components to control the respective components such that a washing course, a rinsing course, a spin-drying course, a drying course, and cycles included in each course may be performed.

The cabinet 110 may include a base 118 on which the respective components are located in a supported state, a front panel 111 having an opening 112 through which laundry may be introduced, a left panel 114, a right panel 115, a rear panel 116, and a top panel 117. A door 113 to close the opening 112 may be provided in the opening 112 of the front panel 111.

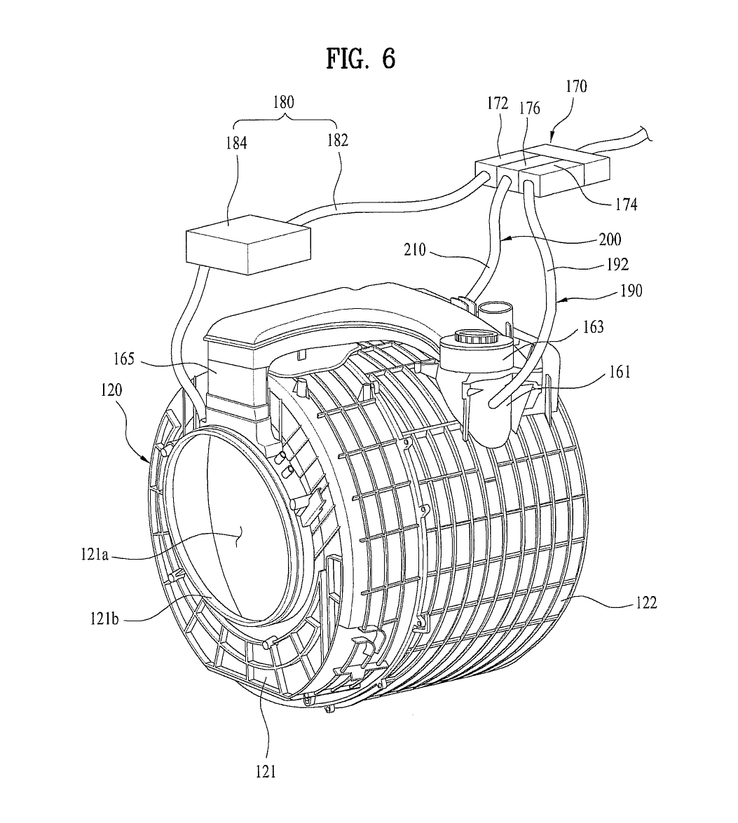

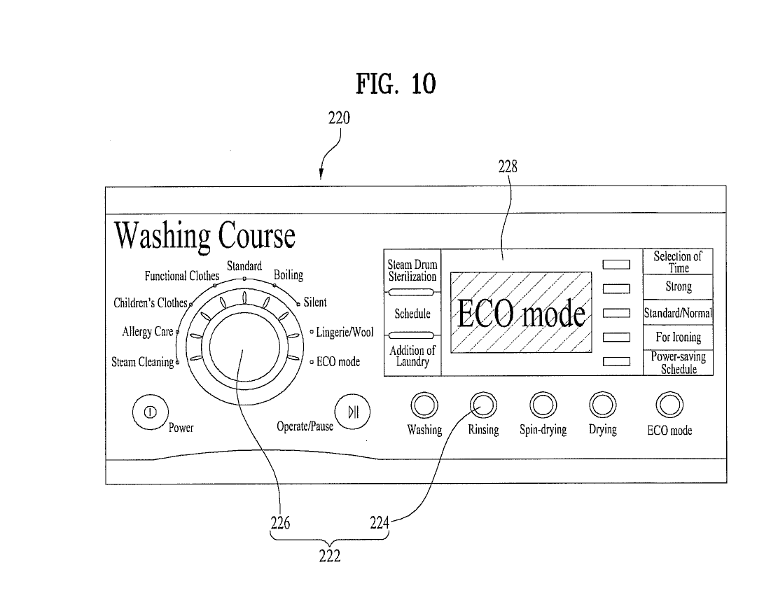

A water supply device 180 (see FIG. 6) to supply water from an external source into the tub 120 may be provided in the inside upper part of the cabinet 110. A drainage device including a drainage hose and a drainage pump to discharge used wash water may be provided in the inside lower part of the cabinet 110. A control panel 220 (see FIG. 10) may be provided at the front panel 111 and connected to the controller 225 to control the laundry treating machine 100 according to user manipulation.

The tub 120 may include a front tub 121 forming the front part of the tub 120 and a rear tub 122 forming the rear part of the tub 120. The front tub 121 and the rear tub 122 may be coupled to each other via coupling members, such as screws, to form a space in which the drum 130 is received.

The front tub 121 may include at the front side thereof an introduction port 123 connected to the door 113 such that laundry is introduced through the introduction port 123. A rim 121b protruding toward the front of the tub 120 may be formed in the inner circumference of the introduction port 123. An air discharge port 165 of the air supply device 160 may be connected to the rim 121b. The rim 121b may include a front gasket 124 to maintain airtightness between the rim 121b and the opening 112 of the front panel 111, and to prevent introduction of foreign matter into a gap between the tub 120 and the drum 130.

The rear tub 122 may be open at the rear thereof. A tub back wall 125 to close the rear of the rear tub 122 and a rear gasket 126 may be provided at the rear of the rear tub 122. The rear gasket 126 may be connected to the tub back wall 125 and the rear tub 122 in a sealed state to prevent leakage of wash water from the tub 120.

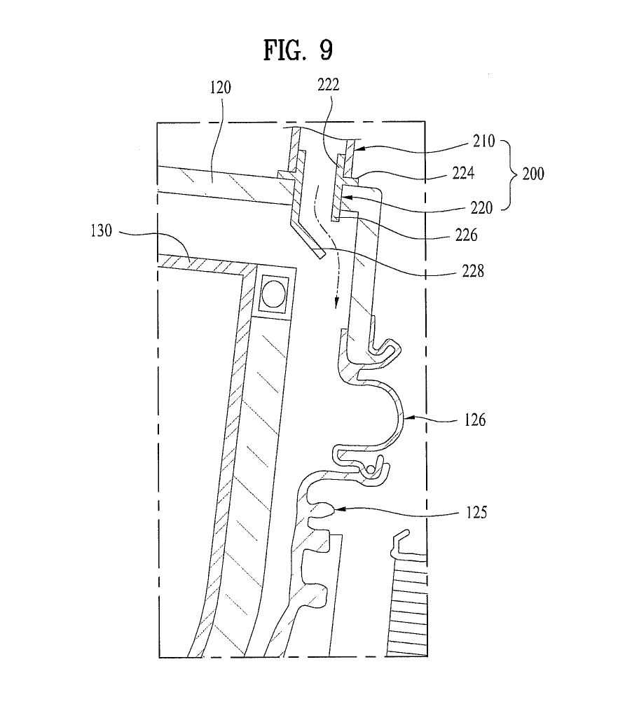

A cooling water supply device 200 (see FIG. 9) to generate condensed water using the rear of the rear tub 120 may be provided at one side of the outer circumference of the rear tub 120. The rear of the rear tub 120 may function as a condensing surface due to the cooling water supplied from the cooling water supply device 200.

During rotation of the drum 130, the tub back wall 125 vibrates together with the drum 130. For this reason, the tub back wall 125 may be spaced from the rear tub 122 by a sufficient distance to prevent interference between the tub back wall 125 and the rear tub 122. The rear gasket 126, disposed between the tub back wall 125 and the rear tub 122, may be made of a flexible material, to allow relative motion between the tub back wall 125 and the rear tub 122 without interference between the tub back wall 125 and the rear tub 122. The rear gasket 126 may have a bellows that may extend to a sufficient length to allow such relative motion (see FIG. 3).

The tub 120 may be upwardly supported by supporters 118a and 118b provided at the base 118 of the cabinet 110, oriented vertically and, may also be fixed by additional coupling members (for example, screws or bolts). In addition, the tub 120 may be fixed to the front panel 111 and the rear panel 116, or to the left panel 114 and the right panel 115, by coupling members.

Also, the tub 120 may have a cooling water supply device 200 at the rear upper part thereof to supply cooling water to cool the inner surface of the tub 120 such that the inner surface of the tub 120 is used as the cooling surface to generate condensed water. The cooling water supply device 200 may be provided at the rear upper part of the rear tub 122. Hereinafter, the cooling water supply device 200 will be described as being provided at the rear upper part of the tub 120, for simply convenience of description, with reference to additional drawings.

The air supply device 160 may be provided at the upper part of the tub 120 to circulate and heat air in the tub 120 during a drying course. That is, the air supply device 160 may be configured to heat air discharged from the tub 120 and to introduce the heated air into the tub 120.

The drum 130 may include a front drum 131, a center drum 137, and a rear drum 132. Weight balancers 134 may be mounted at the front part of the front drum 131 and the rear part of the rear drum 132 to suppress vibration of the drum 130 during rotation. Lifts 133 may be provided at the inner circumference of the center drum 137.

The rear drum 132 may be connected to a spider 136, and the spider 136 may be connected to the rotary shaft 135 so that the drum 130 may be rotated in the tub 120 by rotary force transmitted through the rotary shaft 135.

The rotary shaft 135 may be directly connected to the drive motor 141 through the tub back wall 125. Specifically, the rotary shaft 135, may be directly connected to a rotor of the drive motor 141. The bearing housing 140 may be coupled to the rear facing surface of the tub back wall 125.

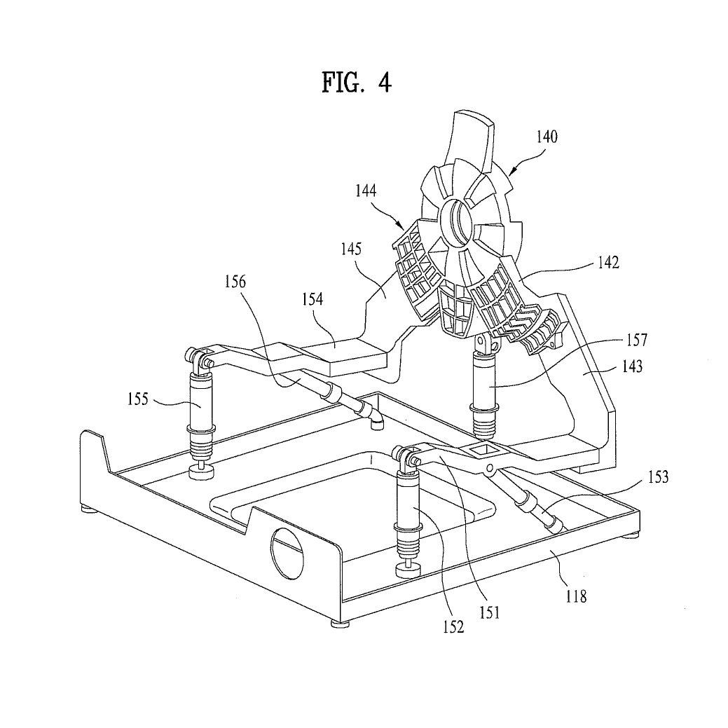

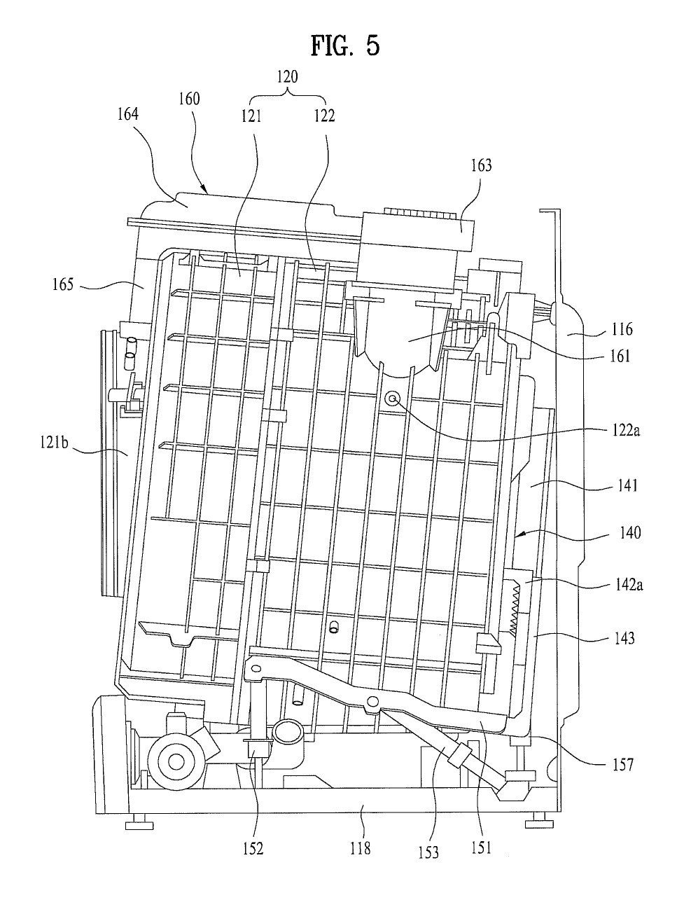

As shown in FIGS. 4 and 5, the suspension device 150 may be coupled to the bearing housing 140 to support the rotary shaft 135, with first and second weights 143 and 145 respectively connected to first and second extensions 142 and 144 of the bearing housing 140, first and second suspension brackets 151 and 154 respectively connected to the first and second weights 143 and 145, and first, second and third spring dampers 152, 155 and 157 and first and second dampers 153 and 156 connected to the first and second suspension brackets 151 and 154 and the bearing housing 140 to elastically support the bearing housing 140.

The bearing housing 140 may rotatably support the rotary shaft 135 between the drive motor 141 and the tub back wall 125. The bearing housing 140 may be elastically supported by the first, second and third spring dampers 152, 155 and 157 and the first and second dampers 153 and 156.

The tub back wall 125, disposed at the rear of the tub 120, may be coupled to one side of the bearing housing 140. The rotary shaft 135, coupled to the drum 130, may extend into the bearing housing 140. The bearing housing 140 may include a bearing to smoothly rotate the rotary shaft 135. The rotary shaft 135 may be supported by the bearing. The drive motor 141 to rotate the rotary shaft 135 may be fastened to the other side of the bearing housing 140.

The first extension 142 and second extension 144 may extend radially from the bearing housing 140 and be arranged symmetrically. The suspension device 150 may be fastened to the first extension 142 and the second extension 144 so that the bearing housing 140 may be elastically supported by the suspension device 150.

The first and second weights 143 and 145 may balance the drum 130 when laundry is received in the drum 130. Also, the first and second weights 143 and 145 may serve as mass in a vibration system in which the drum 130 vibrates. The first and second weights 143 and 145 may be respectively connected to the first extension 142 and second extension 144 of the bearing housing 140.

The first and second suspension brackets 151 and 154 may be respectively connected to corresponding ends of the first and second weights 143 and 145. The first and second suspension brackets 151 and 154 may respectively extend from opposite lower parts of the tub 120 to the front of the tub 120. The first and second suspension brackets 151 and 154 may be supported by the first, second and third spring dampers 152, 155 and 157 and the first and second dampers 153 and 156.

The first spring damper 152 may be connected between the first suspension bracket 151 and the base 118, and the second spring damper 155 may be connected between the second suspension bracket 154 and the base 118. The third spring damper 157 may be connected between the bearing housing 140 and the base 118. One rear point and two front left and right points may be supported by the first, second and third spring dampers 152, 155 and 157 to provide for shock absorption.

The first damper 153 may be mounted at an incline between the first suspension bracket 151 and the rear of the base 118, and the second damper 156 may be mounted at an incline between the second suspension bracket 154 and the rear of the base 118.

The first and second weights 143 and 145, the first and second suspension brackets 151 and 154, the first and second spring dampers 152 and 155, and the first and second dampers 153 and 156 may be arranged symmetrically with respect to the rotary shaft of the drum 130. The respective dampers may be coupled to the base 118 via additional rubber bushings such that the respective dampers may tilt at predetermined angles. As a result, the drum 130 and the bearing housing 140 may be elastically supported by the first and second suspension brackets 151 and 154 and the first, second and third spring dampers 152, 155 and 157 such that the drum 130 and the bearing housing 140 float within the tub 120.

The drive motor 141 may be fastened to the rear of the bearing housing 140, and directly coupled to the rotary shaft 135. Speed of the drive motor 141 may be controlled by a controller.

The air supply device 160 may include an air collection port 161 formed at an outer circumference of the tub 120, a blowing fan 163 to collect and move air through the air collection port 161, a heating duct 164 to heat the air moved by the blowing fan 163, and an air discharge port 165 to guide the air heated by the heating duct 164 back into the tub 120.

The air collection port 161 may extend through one side of the outer circumference of the tub 120. A lint filter 162 to filter lint generated during drying may be provided at a circumferential portion of the tub 120 corresponding to the air collection port 161 such that the lint filter 162 extends along the circumference of the tub 120.

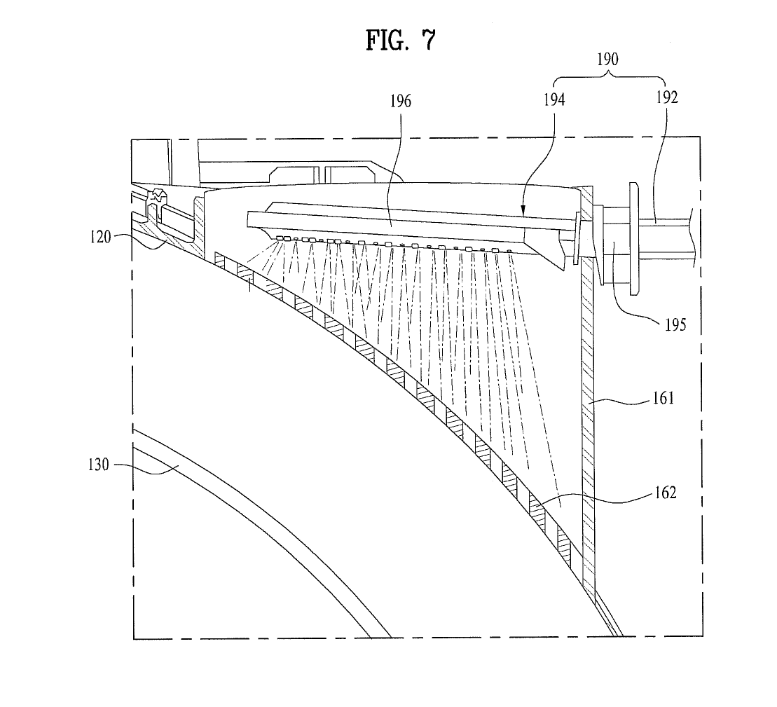

A filter cleaning device 190 may be provided at the inside of the air collection port 161 (see FIG. 7). The filter cleaning device 190 may be provided to separate lint from the lint filter 162 such that the lint is collected in the tub 120.

The blowing fan 163 may be provided at an upper end of the air collection port 161. Upon operation of the blowing fan 163, air in the tub 120 may be drawn into the air collection port 161 and directed to the heating duct 164.

The heating duct 164 may heat the air moved by the blowing fan 163 to generate hot air. A heater may heat the air moving in the heating duct 164. The air heated by the heating duct 164 may be supplied into the tub 120 through the air discharge port 165.

Wash water to wash and rinse laundry, cleaning water to clean the lint filter 162, and cooling water to cool the tub 120 and generate condensed water may be supplied to the laundry treating machine 100 having the above-stated construction.

As shown in FIG. 6, the laundry treating machine 100 may include, at an upper part thereof, a valve assembly 170 to selectively or simultaneously supply water from the external water source to the respective components (for example, the water supply device 180, the filter cleaning device 190, and the cooling water supply device 200).

The valve assembly 170, may include a plurality of valves corresponding to the respective components to which water is to be supplied. That is, the valve assembly 170 may include a water supply valve 172 to control the supply of wash or rinse water to the water supply device 180, a cleaning water valve 174 to control the supply of cleaning water to the filter cleaning device 190, and a cooling water valve 176 to control the supply of cooling water to the inner surface of the tub 120 to generate condensed water. In certain embodiments, the valve assembly 170 may include one or more additional valves in a case in which one or more other components (for example, a steam generator) using water are further provided.

The water supply device 180 may include a water supply line 182 to receive wash water from the water supply valve 172 and a detergent supply device 184 coupled to the water supply line 182 to receive detergent such that the water supplied through the water supply line 182 is introduced into the tub 120 together with the detergent. The wash water having passed through the detergent supply device 184 may be supplied into the tub 120 from the front of the tub 120 through an additional hose.

The filter cleaning device 190 may include a cleaning water line 192 to receive cleaning water from the cleaning water valve 174 and a spray nozzle 194 extending through the air collection port 161, fixed to the inside of the air collection port 161, and connected to the cleaning water line 192 outside the air collection port 161 (see FIG. 7).

The spray nozzle 194 may include a fastening member 195 fixed to the inside of the air collection port 161 and, at the same time, connected to the cleaning water line 192 and a spreading device 196 coupled to the fastening member 195 and having a plurality of nozzles uniformly arranged to spray cleaning water onto substantially the entirety of the lint filter 162. The fastening member 195 and the spreading device 196 may have hollow parts, which communicate with each other. The spray nozzle 194 may have various other internal and external structures, and a detailed description thereof will be omitted.

The cooling water supply device 200 may generate condensed water at the inner circumference of the tub 120 using the inner circumference of the tub 120 as a cooling surface to remove moisture from humid air used to dry laundry. To this end, the cooling water supply device 200 may include a cooling water line 210 to receive cooling water from the cooling water valve 176 and a cooling water nozzle 220 disposed at the rear upper side of the tub 120 to spray cooling water toward a rear inner surface of the tub 120.

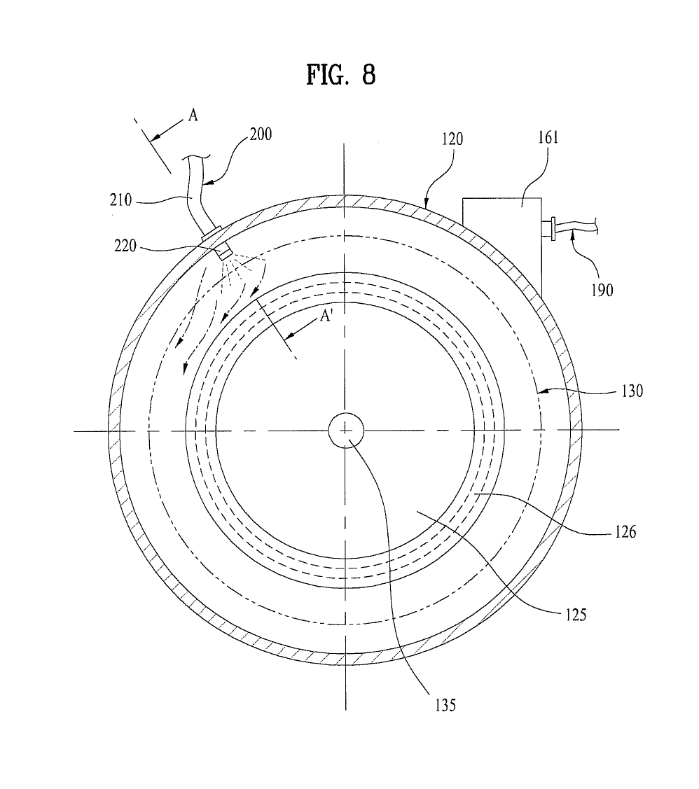

As shown in FIGS. 8 and 9, the cooling water nozzle 220 of the cooling water supply device 200 may be provided at the rear upper part of the tub 120. The cooling water nozzle 220 may be positioned at a side of the tub opposite the air collection port 161. For example, as shown in FIG. 8, the cooling water nozzle 220 may be located at an angle of about 20 to 40 degrees with respect to a vertical axis passing through the rotary shaft 135. The cooling water nozzle 220 may be located at such a position so that cooling water sprayed from the cooling water nozzle 220 may smoothly flow along the rear of the tub 120.

That is, if the cooling water nozzle 220 were located at the middle upper part of the tub 120, cooling water sprayed from the cooling water nozzle 220 would flow vertically along the rear gasket 126 and the tub back wall 125 coupled to the rear of the tub 120. As a result, a flow area of the cooling water would be relatively small, and, time to cool the rear of the tub 120 relatively short, deteriorating a cooling effect of the tub 120. If the cooling water nozzle 220 were instead located at the edge of the tub 120, a flow area of cooling water sprayed from the cooling water nozzle 220 would be reduced and time to cool the rear of the tub 120 would be short, deteriorating a cooling effect of the tub 120.

On the other hand, in a case in which the cooling water nozzle 220 is provided at an angle of about 20 to 40 degrees, with respect to the vertical axis, on an opposite side of that vertical axis from the air collection port 161, as described above, cooling water sprayed from the cooling water nozzle 220 may flow downward along the rear of the tub 120 for a relatively long period of time and over a relatively large flow area to cool the tub 120, improving a cooling effect of the tub 120. That is, when generating condensed water using the inner surface of the tub 120, the condensed water may be generated using a wider area, thereby improving a condensed water generation effect.

The cooling water nozzle 220 of the cooling water supply device 200 may spray cooling water supplied from the cooling water line 210 widely onto the rear of the tub 120. The cooling water nozzle 220 may have a hollow body. A connection end 222, to which the cooling water line 210 is connected, may be formed at the upper part of the cooling water nozzle 220, and a nozzle end 226, which is located inside the tub 120, may be formed at the lower part of the cooling water nozzle 220. A catching end 224 may be formed between the connection end 222 and the nozzle end 226 to mount the cooling water nozzle 220 to the tub 120. A deflection plate 228 to deflect cooling water to the rear of the tub 120 in a spreading fashion may be provided at the lower part of the nozzle end 226.

The laundry treating machine 100 as embodied and broadly described herein may selectively perform a drying course without using cooling water, and a drying course using cooling water. To this end, the laundry treating machine 100 may include a control panel 220 as shown in FIG. 10 to allow a user to select a drying course.

As shown in FIG. 10, the control panel 220 may be provided at the upper part of the front panel 111 of the cabinet 110, or other location as appropriate. For example, the control panel 220 may be provided at one side of the top panel 117 or another one of the panels of the cabinet 110.

As shown in FIG. 10, the control panel 220 may include a manipulation device 222 provided above the door 113 to control the operation of the laundry treating machine 100 and a display 228 to display an operation state of the laundry treating machine 100. The manipulation device 222 and the display 228 may be connected to the controller 225 to control the operation of the laundry treating machine 100.

The manipulation device 222 may include a plurality of buttons 224 and a rotary knob 226 to receive user inputs in the operation of the laundry treating machine 100. In selecting a washing time, a schedule, a washing course, a rinsing course, a spin-drying course, a drying course, and/or an economy mode, a user may manipulate the buttons 224 and/or the rotary knob 226 to input and select desired time and a desired course. The controller 225 may control the laundry treating machine 100 according to information received through the manipulation device 222 to selectively perform a washing course, a rinsing course, a spin-drying course, or a drying course during a predetermined period of time.

The manipulation device 222 may include a selection means to select a drying course to be conducted without using cooling water (hereinafter, referred to as an ‘economy mode’). The economy mode may be selected using the rotary knob 226 or one of the buttons 224. The economy mode selection means may be modified in various forms.

The display 228 may display information received and set through the manipulation device 222. The display 228 may include a plurality of light emitting diodes (LEDs) which are successively arranged and a liquid crystal display (LCD). The display 228 may display various kinds of washing information, such as the progress of washing and remaining time, through blinking of the LEDs, text and/or symbols on the LCD. When the economy mode is selected based user manipulation of the manipulation device 222, the display 228 may display that the economy mode has been selected.

Hereinafter, the economy mode operation of the laundry treating machine with the above-stated construction will be described. The economy mode may be performed during a drying process of the laundry treating machine 100. Consequently, a description of a washing course, a rinsing course, and a spin-drying course of the laundry treating machine 100 will be omitted, and only a related drying course will hereinafter be described. The respective components mentioned below should be understood with reference to the above description and the drawings.

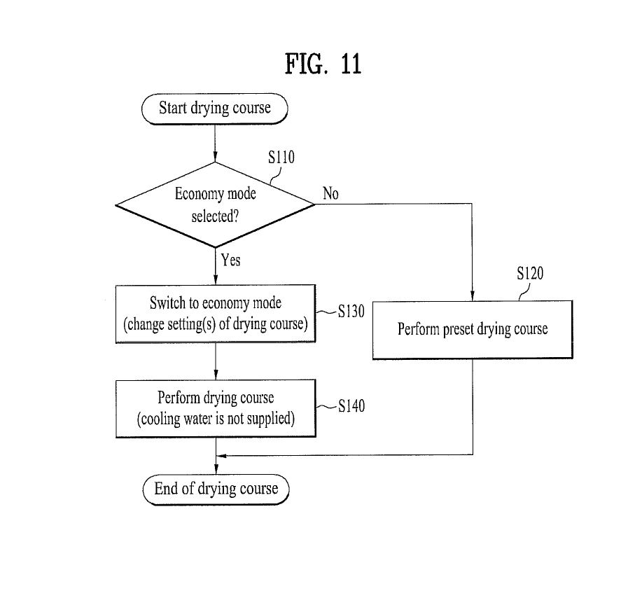

FIG. 11 is a flowchart of a drying course performed by the laundry treating machine as embodied and broadly described herein.

An economy mode may be selected by a user for a drying course of an existing washing process (including a washing course, a rinsing course, a spin-drying course, and a drying course). Alternatively, a drying course may be performed in the economy mode when only the drying course is performed, without performance of the other washing courses. When the economy mode is added to the drying course of the existing washing process, the same washing process is performed, and therefore, a detailed description thereof will be omitted. Hereinafter, only the drying course performed in the economy mode will be described in detail.

The user may select the economy mode before performing the washing process. User selection of the economy mode may be achieved using one of the buttons 224 and/or the rotary knob 226 provided at the manipulation device 222 of the control panel 220. Also, when the user selects the economy mode, the controller 225 may control the display 228 to display that the economy mode has been selected.

Subsequently, the controller 225 may perform a washing process selected by the user, if appropriate, and determine whether the economy mode has been selected by the user before a drying course is performed (S110).

Upon determining that the economy mode has not been selected by the user, the controller 225 controls a preset drying course to be performed (S120).

In such a preset drying course, first, the blowing fan 163 of the air supply device 160 is operated, causing air from the tub 120 to be drawn through the air collection port 161 and forwarded to the heating duct 164. The air forwarded to the heating duct 164 is heated by the heater provided in the heating duct 164. The heated air is supplied into the tub 120 through the air discharge port 165. The air supplied into the tub 120 dries laundry in the tub 120 (specifically, the drum 130). The air used to dry the laundry becomes humid due to the moisture evaporated from the laundry. The humid air is drawn back into the air collection port 161 and is re-circulated.

Lint generated from the laundry during drying is filtered by the lint filter 162 positioned at the air collection port 161. The filtered lint is separated from the lint filter 162 through the operation of the filter cleaning device 190 during the drying process or during a washing/rinsing process, is introduced into the tub 120, and is discharged from the laundry treating machine 100 through the drainage device.

In addition, moisture generated from the laundry during the above process is circulated together with the air. The moisture is removed by the cooling water supply device 200. First, when cooling water is supplied under control of the cooling water valve 176, the cooling water flows along the cooling water line 210 and is sprayed onto the rear of the tub 120 through the cooling water nozzle 220. The cooling water sprayed onto the rear of the tub 120 flows downward along the rear of the tub 120 to cool the inner circumference of the tub 120. At this time, heat exchange occurs between the humid air and the surface of the tub 120. As a result, moisture contained in the humid air is condensed at the rear of the tub 120, and therefore, condensed air is generated.

The cooling water supplied by the cooling water supply device 200 is discharged from the laundry treating machine 100 through the drainage device after cooling the rear of the tub 120. Supply time and intervals of the cooling water supplied by the cooling water supply device 200 may be shorter than drainage time and intervals of the cooling water drained by the drainage device.

Even in this case, a condensing amount may be greater than when using a condensing duct 14 as shown in FIG. 14. That is, in the condensing duct 14, condensation occurs at a smaller area than the inner circumference of the tub 120. In a case in which condensation occurs at the inner circumference of the tub 120, the cooling surface for condensation is larger than that of the condensing duct 14. Consequently, a larger condensing surface is provided, thereby improving condensing efficiency. Furthermore, the cooling water is supplied to the rear of the tub 120, and therefore, cooling efficiency is greater than in a case in which the cooling water is not supplied to the rear of the tub 120.

On the other hand, upon determining that the economy mode has been selected by the user (S110), indicating that cooling water will not be supplied during the drying course, the controller 225 may change performance conditions (for example, drying time, temperature of hot air, rotational speed of the drum, etc.) of the preset drying course (S130). That is, in the economy mode, the drying course is performed in a state in which cooling water is not supplied. As a result, the amount of condensed water generated in the economy mode may be lower than the amount of condensed water generated when cooling water is supplied during the existing drying course. In order to dry laundry, therefore it may be necessary to increase time during which the drying course is performed, to increase the temperature of hot air or supply time of the hot air, or to increase rotational speed and rotational frequency of the drum.

Subsequently, the controller 225 controls the drying course to be performed, without supplying cooling water to generate condensed water, in a state in which the conditions have been changed (S140). The drying course in the economy mode may be performed as follows.

First, the blowing fan 163 of the air supply device 160 is operated, and air from the tub 120 is drawn into the air collection port 161 and forwarded to the heating duct 164, where it is heated by the heater provided in the heating duct 164. The heated air is supplied into the tub 120 through the air discharge port 165. The air supplied into the tub 120 dries laundry in the tub 120 (specifically, the drum 130). The air used to dry the laundry becomes humid due to moisture evaporated from the laundry. The humid air is introduced back into the air collection port 161 and is re-circulated.

Lint generated from the laundry during drying of the laundry is filtered by the lint filter 162 provided the air collection port 161. The filtered lint is separated from the lint filter 162 through the operation of the filter cleaning device 190 during the drying process or during a washing/rinsing process, is introduced into the tub 120, and is discharged from the laundry treating machine 100 through the drainage device.

High temperature humid air remains in the tub 120, whereas air outside the tub 120 has lower temperature than the air inside the tub 120. For this reason, the air may be condensed at the inner circumference of the tub 120 due to the temperature difference between the inside and the outside of the tub 120 even though no cooling water is supplied from the cooling water supply device 200. That is, moisture contained in the humid air is condensed at the rear of the tub 120 through heat exchange between the surface of the tub 120 and the humid air. As a result, condensed water is generated.

In a laundry treating machine as embodied and broadly described herein, the inner surface of the tub forms a condensing surface to remove moisture from hot air used to dry laundry. As a result, a greater condensing surface may be formed, thereby improving condensing efficiency and preventing waste of cooling water for condensation.

Also, the laundry treating machine as embodied and broadly described herein may include the lint filter to filter lint from air circulated in the laundry treating machine after drying laundry, thereby preventing malfunction of the laundry treating machine due to accumulation of lint.

Also, the laundry treating machine as embodied and broadly described herein may include the filter cleaning device to clean the lint filter, thereby achieving easy cleaning of the lint filter.

In a laundry treating machine and the control method thereof, as embodied and broadly described herein, it may be possible to select the use of cooling water to generate condensed water according to user request during a drying course such that cooling water is only supplied when desired by a user, thereby preventing unnecessary use of cooling water.

Also, in a laundry treating machine and the control method thereof, as embodied and broadly described herein, the condensing structure to remove moisture from hot air used to dry laundry may be improved, thereby improving condensing efficiency.

Furthermore, in a laundry treating machine and the control method thereof, as embodied and broadly described herein, the laundry treating machine may include the lint filter to filter lint from air and the filter cleaning device to clean the lint filter, thereby preventing malfunction of the laundry treating machine due to accumulation of lint.

A laundry treating machine and control method thereof are provided that performs a drying course to dry laundry in a state in which a supply of cooling water is interrupted when a user does not wish to use cooling water during a drying course.

A laundry treating machine and control method thereof are provided wherein a condensing structure to remove moisture from hot air used to dry laundry is improved, thereby improving condensing efficiency.

A laundry treating machine and control method thereof are provided including a lint filter to filter lint from air and a filter cleaning unit to clean the lint filter.

A laundry treating machine as embodied and broadly described herein may include a tub to receive wash water, a drum rotatably provided in the tub, an air supply unit to supply air to the tub, a cooling water supply unit to supply cooling water to an inner surface of the tub such that moisture contained in air is condensed at the inner surface of the tub, and a controller to control the cooling water supply unit to selectively supply the cooling water according to user selection.

The laundry treating machine may also include a control panel to select a drying course to dry laundry while supplying cooling water, and a drying course to dry laundry while not using cooling water.

The air supply unit may be located at an upper part of the tub to collect air on an outer circumference of the tub and to supply the air to a front of the tub.

The tub may be provided with a cooling water supply unit to supply cooling water to a rear inner surface of the tub such that the rear inner surface of the tub forms a condensing surface to generate condensed water.

The cooling water supply unit may include a cooling water line forming a route along which the cooling water flows and a cooling water nozzle fixed to the tub to spray the cooling water to a rear of the tub.

The laundry treating machine may also include a lint filter to filter lint from the air circulated by the air supply unit and a filter cleaning unit to supply cleaning water to the lint filter to remove the lint from the lint filter.

The filter cleaning unit may spray cleaning water to an inside of the tub from an outside of the lint filter.

The controller may control operation of the cooling water supply unit to be stopped and a drying course to be performed. Alternatively, the controller may control the cooling water supply unit to be operated and a drying course to be performed.

In another embodiment, a control method of a laundry treating machine may include selecting a drying course and determining the selected drying course, supplying cooling water necessary to generate condensed water and interrupting the supply of the cooling water according to the determined drying course, and performing the drying course.

The step of selecting the drying course may include selecting a drying course using the cooling water and a drying course not using the cooling water.

The step of performing the drying course may include, when the drying course not using the cooling water is selected, increasing drying time such that the drying time of the drying course not using the cooling water is longer than drying time of the drying course using the cooling water, and performing the drying course.

The step of performing the drying course may include, when the drying course using the cooling water is selected, supplying cooling water to an inner circumference or a rear of a tub, and performing the drying course.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling a laundry machine, the method comprising:
receiving a drying course selection;
determining operation parameters associated with the received drying course selection;
either supplying cooling water to generate condensed water or interrupting a supply of cooling water based on the determined operation parameters associated with the received drying course selection; and
performing the selected drying course.

2. The method of claim 1, wherein receiving a drying course selection comprises receiving one of a plurality of drying course selections, including a first drying course comprising supplying cooling water and mixing the supplied cooling water with air circulated while performing the drying course to generate condensed water, and a second drying in which cooling water is not supplied.

3. The method of claim 2, wherein, when receiving a drying course selection comprises receiving the second drying course performing the selected drying course comprises, increasing drying time such that drying time associated with the second drying course is longer than drying time associated with the first drying course.

4. The method of claim 2, wherein, when receiving a drying course selection comprises receiving the first drying course, performing the selected drying course comprises supplying cooling water to an inner peripheral surface of a tub of the laundry machine while performing the selected drying course.

5. The method of claim 4, wherein supplying cooling water to an inner peripheral surface of a tub comprises directing cooling water to an inner rear wall surface of the tub.

6. A laundry machine, comprising:
a tub;
a drum rotatably provided in the tub;
an air supply device supplying air to the tub;
a cooling water supply device supplying cooling water to an inner surface of the tub such that moisture contained in air circulated by the air supply device is condensed at the inner surface of the tub; and
a controller configured to receive an operation course selection and to control the cooling water supply device to selectively supply cooling water based on the received operation course selection.

7. The laundry machine of claim 6, further comprising a control panel providing for the selection of operation course, including selection of a first drying course to dry laundry while supplying cooling water and a second drying course to dry laundry without supplying cooling water.

8. The laundry machine of claim 6, wherein the air supply device is positioned at an upper portion of the tub, and wherein the air supply device collects air from the tub at an outer circumferential portion of the tub and supplies the collected air to the tub at a front portion of the tub.

9. The laundry machine of claim 6, further comprising a cooling water supply device coupled to the tub to supply cooling water to an inner rear surface of the tub such that the inner rear surface of the tub forms a condensing surface to generate condensed water.

10. The laundry machine of claim 9, wherein the cooling water supply device comprises:
a cooling water nozzle fixed to the tub to spray cooling water toward the inner rear surface of the tub; and
a cooling water line that supplies cooling water to the cooling water nozzle.

11. The laundry machine of claim 6, further comprising:
a lint filter provided in an air circulation path defined by the air supply device to filter lint from the air circulated by the air supply device; and
a filter cleaning device positioned in communication with the lint filter to direct cleaning water to the lint filter to remove lint from the lint filter.

12. The laundry machine of claim 11, wherein the lint filter is positioned within an opening formed in an outer circumferential surface of the tub, and wherein the filter cleaning device sprays cleaning water at the lint filter from an outer side of the lint filter such that the cleaning water flows through the lint filter and into an inside of the tub, and removes lint accumulated on an inner side of the lint filter as it flows through the lint filter.

13. The laundry machine of claim 6, wherein the controller is configured to control operation of the cooling water supply device such that the cooling water supply device is operated to supply cooling water to the inner surface of the tub as a first drying course is performed.

14. The laundry machine of claim 13, wherein the controller is configured to control operation of the cooling water supply device such that operation of the water supply device is stopped while a second drying course is performed.

15. A method of controlling a laundry machine, the method comprising:
receiving a drying course selection from a plurality of drying courses including a first drying course in which cooling water is supplied while heated air is circulated to facilitate condensation and a second drying course in which cooling water is not supplied while heated air is circulated;
performing the selected drying course.

16. The method of claim 15, wherein, when receiving a drying course selection comprises receiving selection of the first drying course, performing the selected drying course comprises:
operating a fan and drawing air out of a tub of the laundry machine and into a heating duct;
heating the air as the air flows through the heating duct;
supplying the heated air from the heating duct back into the tub; and
supplying cooling water to an inner surface of the tub as the air circulates from the tub, through the heating duct and back into the tub, to cool the inner surface of the tub and remove moisture from the air through heat exchange as it circulates.

17. The method of claim 15, wherein, when receiving a drying course selection comprises receiving selection of the second drying course, performing the selected drying course comprises:
adjusting at least one of a drying time, a drying temperature or a rotation speed of a drum of the laundry machine such that the drying time, drying temperature and rotation speed associated with the second drying course are greater than those associated with the first drying course;
operating a fan and drawing air out of a tub of the laundry machine and into a heating duct;
heating the air as the air flows through the heating duct; and
supplying the heated air from the heating duct back into the tub.

18. The method of claim 15, further comprising performing a filter cleaning operation while performing the selected drying course, comprising:
supplying cleaning water to a filter cleaning nozzle positioned at an outer side of a tub of the laundry machine;
spraying the cleaning water from the filter cleaning nozzle onto an outer side of a filter positioned in an opening in a peripheral wall of the tub and through the filter to release debris accumulated on an inner side of the filter; and
draining the released debris and the cleaning water from the tub.
